(19) United States
(12) Patent Application Publication
(10) Pub. No.: US 2023/0136148 A1
(43) Pub. Date: May 4, 2023

(54) APPARATUS FOR MACHINING DOUBLE ENVELOPING WORM SHAFT

(71) Applicants: Gyu Bong Han, Bucheon-si (KR); SUNG JIN TECH CO., LTD., Bucheon-si (KR)

(72) Inventor: Gyu Bong HAN, Bucheon-si (KR)

(73) Assignees: SUNG JIN TECH CO., LTD., Bucheon-si (KR); Gyu Bong Han, Bucheon-si (KR)

(21) Appl. No.: 17/845,305

(22) Filed: Jun. 21, 2022

(30) Foreign Application Priority Data
Nov. 4, 2021 (KR) 10-2021-0150614

(51) Int. Cl. B23F 13/06

(52) U.S. Cl. CPC B23F 13/06

(57) ABSTRACT

Provided is an apparatus for machining a double enveloping worm shaft, and more particularly, to an apparatus for machining a double enveloping worm shaft, which cuts threads on a workpiece having a double enveloping body having a central portion formed therein in a concave arc-shaped outer circumferential surface and in which teeth of the machined double enveloping worm shaft are cut to a uniform depth while being always directed toward a central axis of a worm wheel, machining precision of the double enveloping worm shaft is increased, and thus post-machining is not required.

### CROSS REFERENCE TO RELATED APPLICATION

This application claims priority to and the benefit of Korean Patent Application No. 10-2021-0150614 filed on Nov. 4, 2021, the disclosure of which is incorporated herein by reference in its entirety.

### BACKGROUND

### 1. Field of the Invention

The present disclosure relates to an apparatus for machining a double enveloping worm shaft, and more particularly, to an apparatus for machining a double enveloping worm shaft which forms threads by cutting and machining a workpiece having a double enveloping body having a central portion formed therein in a concave arc-shaped outer circumferential surface and in which teeth of the machined double enveloping worm shaft are cut to a uniform depth while being always directed toward a central axis of a worm wheel so as to increase machining precision of the double enveloping worm shaft so that post-machining is not required.

### 2. Discussion of Related Art

Unlike most general gears, worm gears transfer forces while worm shafts rotate and slide on tooth surfaces of worm wheels and are used when two shafts are orthogonal to each other.

Since the worm gears can achieve a large gear ratio of 10:1 or more, the design of a device that requires the use of a plurality of gear sets can be simplified, and thus the worm gears are used as power transmission units (reducers) of various devices. However, in the case of general worm gears according to the related art, since a thread of the worm shaft has a cylindrical structure, there are disadvantages in terms of heat generation and low efficiency due to contact between the worm wheels and the small tooth surfaces.

Double enveloping worm shaft gears have been developed to address this problem.

A double enveloping worm shaft gear is a worm shaft gear which uses a worm shaft having a double enveloping threaded part instead of a cylindrical threaded part according to the related art.

In detail, as illustrated in FIG. 1A, a double enveloping worm shaft is configured such that a tooth shape of a thread 1a is formed in a concave double enveloping body of which the outer diameter is gradually decreased toward a central portion in a lengthwise direction. Unlike a general cylindrical worm shaft that makes point or line contact, the thread 1a of the double enveloping worm shaft 1 has a structure surrounding a gear part of the worm wheel 3. As a contact area for the gear part of the worm wheel is significantly increased as compared to the general cylindrical worm shaft, lubricity is increased through a dispersion of force, heat generation is reduced, noise and vibrations are minimized, and thus excellent durability is ensured while energy consumption is reduced.

Due to the above advantages, the demand for the double enveloping worm shaft (worm gear) is increasing. However, in the case of a method of machining the double enveloping worm gear according to the related art, as illustrated in FIG. 1B, as a cutter cuts a rotating workpiece while moving, the double enveloping worm shaft 1 is machined. Thus, there is a problem that as an orientation of the tooth shape is not directed toward the center of the worm wheel, a contact surface with the worm wheel is not uniform or additional post-machining should be performed to uniformly make the contact surface.

In order to address this problem, a technology (hereinafter, referred to as the related art) of cutting and machining a double enveloping threaded part while a cutter rotates in a circular arc with respect to a workpiece as in Korean Patent Application Publication No. 10-2016-0028198 and Korean Patent Application Publication No. 10-2020-0034181 is presented as a device for machining a double enveloping worm shaft.

In the related art, as illustrated in FIG. 1C, as a rotating body equipped with the cutter rotates about a central axis C1, the cutter rotates in a circular arc to cut and machine an outer surface of the double enveloping body to form a threaded part thereon.

However, the size of the double enveloping worm shaft varies greatly according to a gear ratio of the worm wheel.

Thus, as in the related art, when the double enveloping worm shaft is machined by the rotating cutter, the double enveloping worm shaft is machined while an orientation of the tooth shape is formed according to a rotational radius of the rotating cutter regardless of the curvature of the double enveloping worm shaft. Thus, when the worm shaft is actually engaged with the worm wheel, tooth surface contact between the double enveloping worm shaft and the worm wheel is not constant, and thus the advantages of the double enveloping worm shaft gear are reduced or post-machining should be added to prevent the reduction in the advantages.

That is, as illustrated in FIG. 1C, the curvature of the double enveloping threaded part varies according to the size (radius) of the worm wheel. In the related art, since the rotational radius of the cutter is always the same, the center of the cutter is always constant, and thus the orientation of the tooth shape is not aligned with the center of the worm wheel due to a difference between the curvature of the double enveloping threaded part and the rotational radius of the cutter.

In other words, in FIG. 1C, the locations of centers C1, C2, and C3 of the double enveloping threaded parts are different according to curvatures R1, R2, and R3 thereof. In the related art, since the center C1 of the rotational radius of the cutter is always constant, the machining precision of the double enveloping threaded part is degraded or the machining becomes impossible. Accordingly, in the related art, the difference is compensated for by adjusting the location of the cutter in a front-rear direction according to the curvature of the double enveloping threaded part. However, even in this case, since the actual rotational radius of the cutter is always constant, as the orientation of the tooth shape is aligned with the rotational center of the cutter rather than the center of the worm wheel, the cutting depth is changed, and thus the machining precision is inevitably degraded. In fact, in double enveloping worm shaft gear machining companies, the double enveloping worm shaft is precisely engaged with the worm wheel through post-machining, and thus machining precision and productivity are degraded.

### SUMMARY OF THE INVENTION

The present disclosure is directed to providing an apparatus for machining a double enveloping warm shaft, in which, when a double enveloping worm shaft is machined, a cutting depth is formed uniformly as all orientations of teeth are formed uniformly toward a center of a worm wheel, and thus machining precision is increased, and thus productivity can be improved without additional post-machining.

According to an aspect of the present disclosure, there is provided an apparatus for machining a double enveloping worm shaft, the apparatus including a bed including a main shaft for rotating a workpiece having a double enveloping body and a tailstock for fixing the workpiece to the main shaft, a rotation unit provided with a rotation plate which rotates in a left-right direction and on which the bed is mounted, an alignment unit that moves the bed in a front-rear direction and the left-right direction so that a circular arc cutting surface of the double enveloping body is disposed in a concentric circle structure with a rotational path of the rotation plate in reference to a central point of the rotation plate, and a cutter fixed to a central side of the rotation plate to face the circular arc cutting surface of the double enveloping body, wherein, while the workpiece revolves at an outer edge of the cutter, a thread of the double enveloping worm shaft is machined in the circular arc cutting surface of the double enveloping body.

The rotation unit may include a worm shaft rotated by a motor and a worm wheel coupled to the rotation plate and engaged with the worm shaft.

The apparatus may include an angle changing unit which is provided below the rotation unit and changes a mounting angle of the workpiece as the rotation unit rotates in the left-right direction with respect to the cutter.

The angle changing unit may include a base that has a hemispherical worm wheel part and a rotation block that rotates while being axially coupled to the base, has an upper surface to which the rotation unit is coupled, and includes a worm shaft part engaged with the hemispherical worm wheel part.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1A is a cross-sectional view of a main part for describing a double enveloping worm shaft;

FIGS. 1B and 1C are views for describing an apparatus for machining a double enveloping worm shaft according to a related art;

FIGS. 2A to 2C are sample photographs of an apparatus for machining a double enveloping worm shaft according to the present disclosure;

FIG. 3 is a schematic plan view illustrating the present disclosure;

FIG. 4 is a cross-sectional view illustrating a main part of a worm gear of a rotation unit according to the present disclosure; and

FIG. 5 is a schematic front view illustrating an angle change of a cutter according to the present disclosure.

### DETAILED DESCRIPTION OF EXEMPLARY EMBODIMENTS

Since the present disclosure is variously modified and has alternative forms, aspects (or embodiments) thereof will be described in detail. However, it should be understood that the present disclosure is not limited to the specific embodiments and includes all changes, equivalents, and substitutes included in the spirit and technical scope of the present disclosure.

In each drawing, the same reference numerals, particularly, the same reference numerals having the same ten digit and the same one digit or having the same ten digit, the same one digit, and the same alphabet indicate members having the same or similar functions, and unless otherwise described, the member indicated by each reference sign in the drawings may be understood as a member conforming to these standards.

Further, in each drawing, the sizes or thicknesses of components are expressed to be exaggeratedly large (or thick) or small (or thin) or are expressed to be simplified in consideration of convenience of understanding, but the protection range of the present disclosure should not be interpreted as being limited to this expression.

Terms used herein are merely used to describe a specific implementation (an aspect)(or an embodiment) and are not intended to limit the present disclosure. Singular expressions include plural expressions unless clearly otherwise indicated in the context.

It should be understood in the present application that terms such as “include” or “have” are intended to indicate that there are features, numbers, steps, operations, components, parts, or combinations thereof that are described in the specification and do not exclude in advance the possibility of the presence or addition of one or more other features, numbers, steps, operations, components, parts, or combinations thereof.

Unless otherwise defined, all terms used herein including technical or scientific terms have the same meanings as those commonly understood by those skilled in the art to which the present disclosure belongs. Terms defined in commonly used dictionaries should be interpreted as having the same meanings in the context of the related art and may not be interpreted with ideal or excessively formal meanings, unless explicitly defined in the present application.

Terms such as “first” and “second” described herein are merely indicated to distinguish different components from each other and are not limited to a manufacturing order, and names thereof may not coincide with each other in the detailed description and the appended claims.

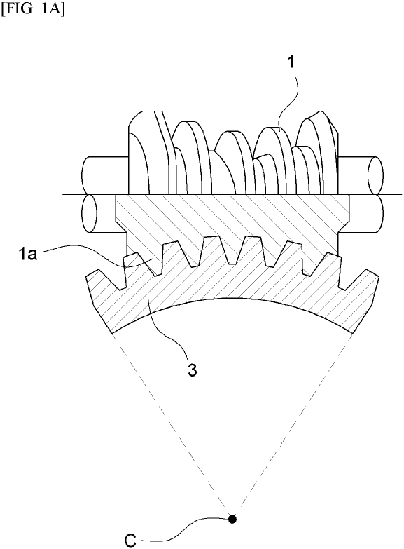

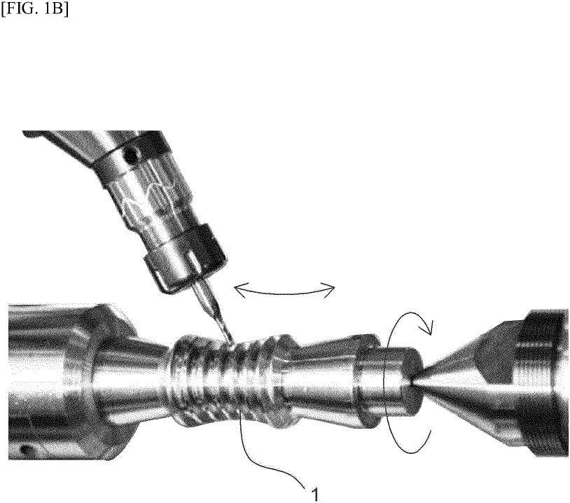

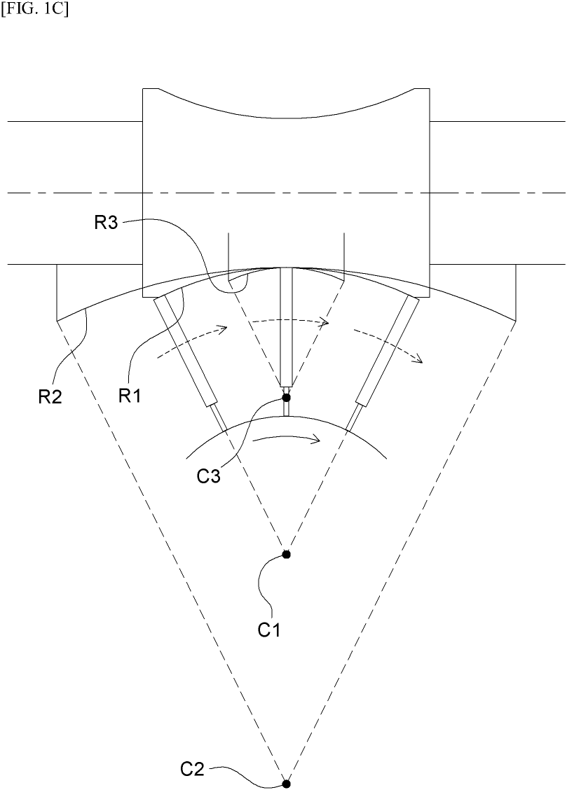

In a description of an apparatus for machining a double enveloping worm shaft according to the present disclosure, for convenience, when an approximate direction standard that is not strict is specified with reference to FIG. 1, an upper side, a lower side, a left side, and a right side are determined with reference to a visible direction when a direction of gravity is taken as a lower side. In the detailed description and the appended claims related to the other drawings, the directions are specifically described according to this standard unless otherwise described.

Hereinafter, an apparatus for machining a double enveloping worm shaft according to the present disclosure will be described with reference to the accompanying drawings.

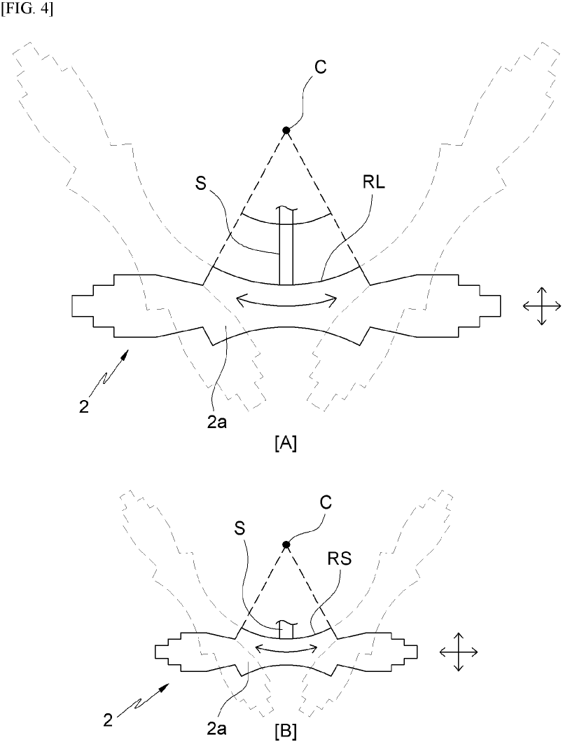

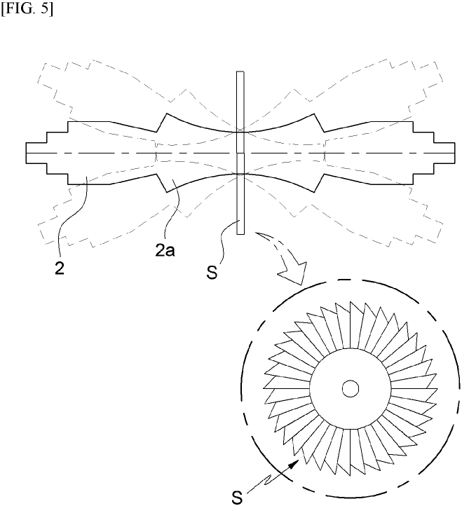

The present disclosure relates to the apparatus for machining a double enveloping worm shaft that roughly includes a bed 10, a rotation unit 20, an alignment unit 30, a cutter, and an angle changing unit 40 as shown in FIGS. 1 to 5.

In detail, the present disclosure includes the bed 10 provided with a main shaft 11 for rotating a workpiece 2 having a double enveloping body 2a and a tailstock 12 for fixing the workpiece 2 to the main shaft 11, the rotation unit 20 provided with a rotation table 21 which may rotate in a left-right direction and on which the bed 10 is mounted, the alignment unit 30 for moving the bed 10 in a front-rear direction and the left-right direction so that a circular arc cutting surface of the double enveloping body 2a is disposed in a concentric circle structure with a rotational path of the rotation table 21 in reference to a central point of the rotation table 21, and a cutter fixed to a central side of the rotation table 21 to face the circular arc cutting surface of the double enveloping body 2a, wherein, while the workpiece 2 revolves at an outer edge of the cutter, a thread of the double enveloping worm shaft 1 is machined in the circular arc cutting surface of the double enveloping body 2a.

In the workpiece 2, the double enveloping body 2a having a constant curvature is machined to have an initial double enveloping shape through milling in advance.

The bed 10 is movable in the front-rear direction and the left-right direction on an upper surface of the rotation unit 20, and the main shaft 11 for rotating the workpiece 2 and the tailstock 12 for fixing the workpiece 2 to correspond to the main shaft 11 are provided on both sides of an upper surface of the bed 10.

The main shaft 11 clamps one end of the workpiece 2 to rotate the workpiece 2 about a lengthwise axis thereof, and a motor omitted from the drawings is connected to an input shaft 13 interlocked with the main shaft 11 through gears so that the main shaft 11 rotates.

The tailstock 12 may move forward or rearward in a lengthwise direction of the workpiece 2 with respect to the main shaft 11 and supports a central point of the other end of the workpiece 2.

An embodiment in which the tailstock 12 is provided in a block that deviates from a line collinear with the main shaft 11 may be identified in the drawing. However, it is apparent that the main shaft 11 and the block in which the tailstock 12 is provided are collinearly arranged as in a tailstock applied to a metal machining facility such as a hobbing machine according to the related art.

In this case, although not illustrated in the drawings, the main shaft 11 and the tailstock 12 may be provided to move forward or rearward in the lengthwise direction of the workpiece 2 in the bed 10.

The rotation unit 20 is coupled to the rotation table 21 so that the rotation table 21 rotates in a left-right horizontal direction above a fixing table 22 and includes a worm gear provided inside the rotation table 21.

The worm gear includes a worm shaft 23 rotated by the motor and a worm wheel 24 coupled to the rotation table 21 and engaged with the worm shaft 23.

An embodiment in which a reduction gear unit 25 including spur gears 25a is provided between the input shaft 13 and the worm shaft 23, and the main shaft 11 and the rotation table 21 are controlled and rotated in conjunction with each other due to a rotational force of the motor supplied to the input shaft 13 may be identified in the drawing. Unlike the drawings, a separate servo motor may be connected to each of the main shaft 11 (the input shaft 13) and the worm shaft 23 to individually control the rotation of the main shaft 11 and the worm shaft 23 in a numerical control manner.

However, since speeds of self-rotation (rotation) and rotational movement (revolution) of the workpiece 2 should be matched at a constant ratio according to a lead value of the double enveloping worm shaft 1, rotational speeds of the main shaft 11 and the rotation table 21 may be simultaneously controlled through changing a gear ratio of the reduction gear unit 25.

In this case, the gear ratio of the reduction gear unit 25 is adjusted according to a reduction ratio of the double enveloping worm shaft gear.

For example, when the double enveloping worm shaft gear having a reduction ratio of 20:1 is machined, and when a worm gear reduction ratio of the rotation table 21 is 90:1, the reduction gear unit 25 is set to have a reduction ratio of 4.5:1 and thus the main shaft 11 and the rotation table 21 are connected to rotate in conjunction with each other.

Further, by applying a split clutch (not illustrated) to a gear connected to the input shaft 13 of the main shaft 11, the interlocking rotation of the main shaft 11 and the rotation table 21 is individually controlled according to the number of thread lines of the double enveloping worm shaft 1.

For example, when the double enveloping worm shaft 1 has one line thread, the clutch is not used, and when the double enveloping worm shaft 1 has two line threads, the clutch is divided by 180 degrees so that only the main shaft 11 may rotate. In addition, when the double enveloping worm shaft 1 has three line threads or four line threads, the split clutch may be configured by applying operation thereof.

In addition, the input shaft 13 is provided with a manual rotation handle which may be used to rotate the rotation table 21 to a predetermined location during setting before machining.

The alignment unit 30 is sufficient as long as the alignment unit 30 fixes the bed 10 after moving the bed 10 in the front-rear direction and the left-right direction, and there is no limitation in the fixing method.

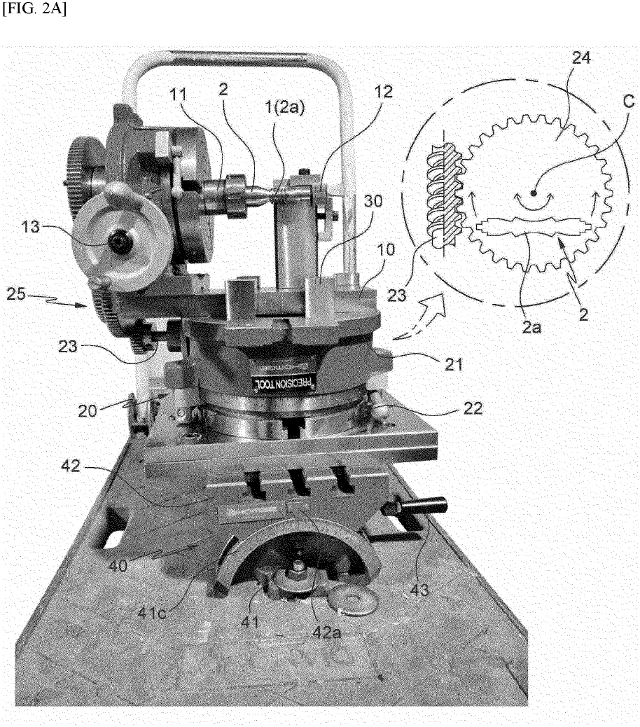

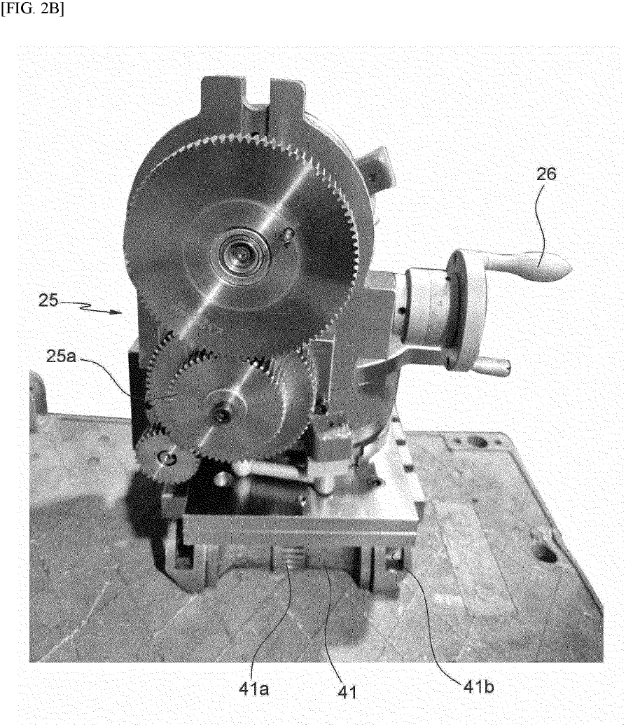

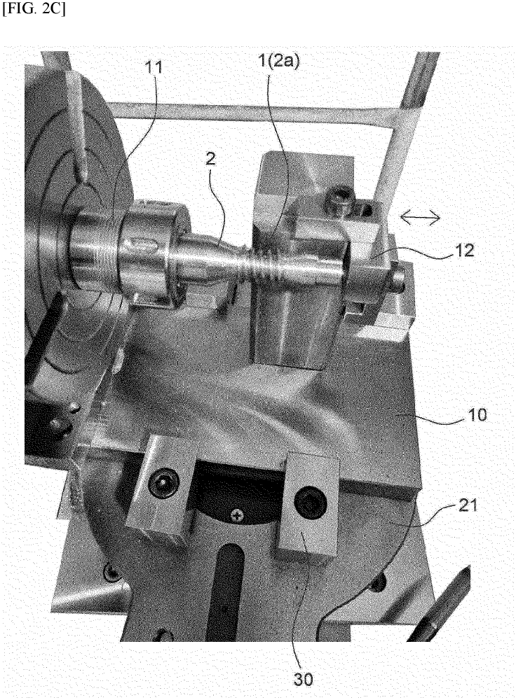

That is, FIGS. 2A to 2C are photograph diagrams of samples for a test operation before the present disclosure is applied to a machine or the like, and the alignment unit 30 including a clamp-type fixing block is representatively illustrated, but the present disclosure is not limited thereto (for example, the location of the bed 10 may be adjusted and fixed using a coordinate movement table of the machine itself.).

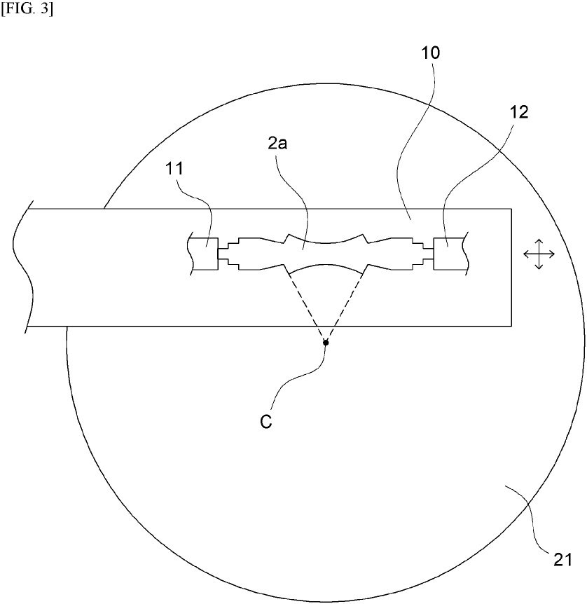

In this case, as illustrated in FIG. 3, by calculating the radius of curvature of the double enveloping body 2a, the bed 10 is set so that the workpiece 2 is spaced apart from a center of the rotation table 21 with the same radial distance.

The cutter is a component for forming a thread by cutting an outer peripheral surface of the double enveloping body 2a, a widely known metal cutting cutter is used as the cutter, and a circular saw blade cutter S is representatively illustrated in the drawings.

The circular saw blade cutter S is installed on a separate fixing shaft and performs the cutting while rotating by the motor. In this case, the circular saw blade cutter S is mounted to stand in line with the center of the rotation table 21 and is fixed so that a distal end of the circular saw blade cutter S is located on a rotation path of the workpiece 2. An accurate setting location of the cutter is adjusted according to the depth of a valley of the thread of the double enveloping worm shaft.

Next, the angle changing unit 40 is provided below the rotation unit 20 and rotates the rotation unit 20 in the left-right direction with respect to the cutter to change a mounting angle of the workpiece 2.

That is, the angle changing unit 40 changes the angle of the workpiece 2 so that the workpiece 2 is inclined to one side with respect to the cutter.

Through this, a lead angle (twisting angle) of the thread cut in the double enveloping body 2a may be adjusted according to a standard.

In detail, the angle changing unit 40 includes a base 41 that has a hemispherical worm wheel part 41a and a rotation block 42 that rotates while being axially coupled to the base 41, has an upper surface to which the rotation unit 20 is coupled, and includes a worm shaft part 42a engaged with the hemispherical worm wheel part 41a.

The base 41 has a hemispherical outer peripheral surface that is convex upward and has the hemispherical worm wheel part 41a formed in a central portion thereof.

The rotation block 42 rotates in the left-right direction while both front and rear ends thereof are axially installed on the base 41, and the worm shaft part 42a intersects and is engaged with an upper portion of the hemispherical worm wheel part 41a.

An embodiment in which the worm shaft part 42a rotates through a handle 43 may be identified in the drawing. However, it is apparent that a separate motor may be additionally connected to the worm shaft part 42a.

In addition, the base 41 is provided with guide grooves 41b in both front and rear ends to guide left-right rotation of the rotation block 42.

Further, the base 41 or the rotation block 42 is provided with a hemispherical goniometer 41c and an indicator 42b so that the angle of the rotation block 42, that is, the workpiece 2, can be accurately and visually identified and adjusted.

Unlike the worm shaft machining method according to the present disclosure, in the present disclosure having this configuration, while the workpiece 2 itself rotates (revolves) with respect to the fixed cutter according to the curvature of the worm wheel forming the double enveloping worm shaft gear, cutting of the thread is performed.

Thus, regardless of the double enveloping body 2a having a relatively large curvature RL or the double enveloping body 2a having a relatively small curvature RS, as the teeth of the thread 1a cut by the cutter are precisely aligned toward a center C of the worm wheel, the depth of cutting is uniformly formed, and thus machining precision is high. Accordingly, additional post-machining is unnecessary, and thus productivity can be improved.

Unlike a rotation-movement cutter cutting method, in the apparatus for machining a double enveloping worm shaft according to the present disclosure, a double enveloping worm shaft is cut and machined while a workpiece itself revolves according to the curvature of a worm wheel in a state in which a cutter is fixed, teeth of the double enveloping worm shaft are cut to a uniform depth while being always directed toward a central axis of a worm wheel, machining precision of the double enveloping worm shaft is increased, post-machining is not required, and thus productivity is excellent.

Rotational movement (revolution) of the workpiece can be precisely controlled using a worm gear.

A lead angle (a twisting angle) of a thread of the double enveloping worm shaft can be variously machined by changing an angle of the workpiece itself.

The lead angle of the double enveloping worm shaft can be precisely adjusted by changing an angle of the rotation unit using a hemispherical worm gear.

The rotational movement (revolution) and self-rotation (rotation) of the workpiece can be precisely controlled by adjusting a rotation reduction ratio of a main shaft and a rotation plate using one motor.

The rotation of the main shaft and the rotation plate is individually controlled using a clutch, and thus cutting and machining can be performed according to the number of thread lines of the double enveloping worm shaft.

Hereinabove, in the description of the present disclosure, the apparatus for machining a double enveloping worm shaft has been mainly described with reference to the accompanying drawings. However, it should be interpreted that the present disclosure may be variously modified, changed, and substituted by those skilled in the art, and such modifications, changes, and substitutions belong to the protection range of the present disclosure.

1. An apparatus for machining a double enveloping worm shaft, the apparatus comprising:
a bed (10) including a main shaft (11) for rotating a workpiece (2) having a double enveloping body (2a) and a tailstock (12) for fixing the workpiece (2) to the main shaft (11);
a rotation unit (20) provided with a rotation table (21) which rotates in a left-right direction and on which the bed (10) is mounted;
an alignment unit (30) that aligns the bed (10) in a front-rear direction and the left-right direction so that the workpiece (2) is spaced apart from and matched with a central point of the rotation table (21)-by ; and
a cutter (S) fixed to a central side of the rotation table (21) to face a circular arc cutting surface of the double enveloping body (2a),
wherein, in a state in which the circular arc cutting surface of the double enveloping body (2a) has a concentric circular structure with a rotation path of the rotation table (21) with respect to the central point of the rotation table (21), while the workpiece (2) revolves at an outer edge of the cutter, a thread of the double enveloping worm shaft (1) is machined in the circular arc cutting surface of the double enveloping body (2a).

2. The apparatus of claim 1, wherein the rotation unit (20) includes a worm shaft (23) rotated by a motor and a worm wheel (24) coupled to the rotation table (21) and engaged with the worn shaft (23).

3. The apparatus of claim 1, further comprising an angle changing unit (40) which is provided below the rotation unit (20) and changes a mounting angle of the workpiece (2) as the rotation unit (20) rotates in the left-right direction with respect to the cutter.

4. The apparatus of claim 3, wherein the angle changing unit (40) includes:
a base (41) that has a hemispherical worm wheel part (41a), and
a rotation block (42) (i) that rotates while being axially coupled to the base (41), (ii) has an upper surface to which the rotation unit (20) is coupled, and (iii) includes a worm shaft part (42a) engaged with the hemispherical worm wheel part (41a).
